(19) United States
(12) Patent Application Publication
(10) Pub. No.: US 2022/0292460 A1
(43) Pub. Date: Sep. 15, 2022

(54) INFORMATION PROCESSING APPARATUS, NON-TRANSITORY COMPUTER READABLE MEDIUM STORING PROGRAM, AND INFORMATION PROCESSING METHOD

(71) Applicant: FUJIFILM Business Innovation Corp., Tokyo (JP)

(72) Inventor: Kaori KIKUCHI, Kanagawa (JP)

(73) Assignee: FUJIFILM Business Innovation Corp., Tokyo (JP)

(21) Appl. No.: 17/463,470

(22) Filed: Aug. 31, 2021

(30) Foreign Application Priority Data
Mar. 11, 2021 (JP) 2021-039223

(51) Int. Cl. G06Q 10/10; G06Q 10/06

(52) U.S. Cl. CPC G06Q 10/103; G06Q 10/105; G06Q 10/063112; G06Q 10/06398

(57) ABSTRACT

An information processing apparatus includes a processor configured to: in a case where plural checkers are assigned to the same portion of the same material, and the material is checked by the plural checkers, display a portion that is assigned to a first checker included in the plural checkers and has not been checked by a second checker included in the plural checkers, on a display of the first checker as a portion to be checked by the first checker.

### CROSS-REFERENCE TO RELATED APPLICATIONS

This application is based on and claims priority under 35 USC 119 from Japanese Patent Application No. 2021-039223 filed Mar. 11, 2021.

### BACKGROUND

### (i) Technical Field

The present invention relates to an information processing apparatus, a non-transitory computer readable medium storing a program, and an information processing method.

### (ii) Related Art

A material may be checked by multiple checkers.

JP2009-223832A discloses a workflow management system that acquires task information containing a task name and detailed information, acquires skill profile information containing a skill name, searches for a similar existing task based on the task information, acquires the concerned person of the searched task, checks consistency with the skill profile information for the searched concerned person, searches for human resources with common skills based on the skill profile information, calculates ranking points of the human resources or the tasks based on the result of checking the consistency and the result of searching for the human resources, and provides the ranking points with priority from the top.

JP2011-145996A discloses a reviewer evaluation apparatus that, for each review of a document, stores information indicating a pointed-out portion in accordance with a pointed-out matter by a reviewer for the document, assigns a weight to each pointed-out matter while increasing the weight in accordance with the number of times of pointing out the identical pointed-out portion, based on the stored information, calculates a ratio of the sum of the weights to the total number of pointed-out matters, as an evaluation value of the reviewer, and outputs the evaluation value.

### SUMMARY

It is conceivable to assign a plurality of checkers to the same portion of the same material, display the assigned portion to each checker as the portion to be checked, and cause each checker to check the same portion. In this case, in a case where the portion which has been already checked by another checker is also displayed to the checker as a portion to be checked, a portion that does not require check may be displayed to the checker as a portion to be checked, and thus the check efficiency of the checker may decrease.

Aspects of non-limiting embodiments of the present disclosure relate to an information processing apparatus, a non-transitory computer readable medium storing a program, and an information processing method for improving the check efficiency of a checker in comparison to a case where a portion which has been checked by another checker is also displayed as a portion to be checked by the checker in a case where a plurality of checkers check the same material.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to: in a case where a plurality of checkers are assigned to the same portion of the same material, and the material is checked by the plurality of checkers, display a portion that is assigned to a first checker included in the plurality of checkers and has not been checked by a second checker included in the plurality of checkers, on a display of the first checker as a portion to be checked by the first checker.

### BRIEF DESCRIPTION OF THE DRAWINGS

Exemplary embodiment(s) of the present invention will be described in detail based on the following figures, wherein:

FIG. 1 is a block diagram illustrating a configuration of an information processing system according to an exemplary embodiment;

FIG. 2 is a block diagram illustrating a configuration of an information processing apparatus according to the present exemplary embodiment;

FIG. 3 is a block diagram illustrating a configuration of a terminal device according to the present exemplary embodiment;

FIG. 4 is a flowchart illustrating a flow of a process in a case where checking a material is requested;

FIG. 5 is a flowchart illustrating a flow of a process in a case where the material is checked;

FIG. 6 is a diagram illustrating a screen displayed in a case where checking a material is requested;

FIG. 7 is a diagram illustrating a specific example of a role;

FIG. 8 is a diagram illustrating a screen displayed in a case where checking a material is requested;

FIG. 9 is a diagram illustrating a screen displayed in a case where a material is checked;

FIG. 10 is a diagram illustrating a checked item;

FIG. 11 is a diagram illustrating a screen displayed in a case where the material is checked;

FIG. 12 is a diagram illustrating a screen displayed in a case where the material is checked;

FIG. 13 is a diagram illustrating a screen displayed in a case where the material is checked;

FIG. 14 is a diagram illustrating a comment of a checker;

FIG. 15 is a diagram illustrating a screen displayed in a case where a content of checking by the checker is evaluated;

FIG. 16 is a diagram illustrating an evaluation of the content of the checking by the checker;

FIG. 17 is a diagram illustrating a screen displayed in a case where the content of the checking by the checker is evaluated;

FIG. 18 is a diagram illustrating points of the checker;

and

FIG. 19 is a diagram illustrating a specific example of the role.

### DETAILED DESCRIPTION

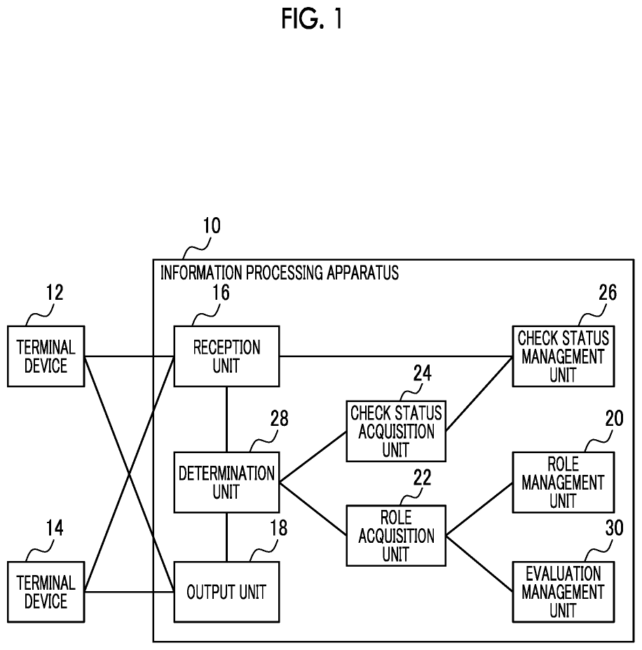

An information processing system according to the present exemplary embodiment will be described with reference to FIG. 1. FIG. 1 illustrates an example of a configuration of the information processing system according to the present exemplary embodiment.

The information processing system according to the present exemplary embodiment includes an information processing apparatus 10 and terminal devices 12 and 14, as an example. The number of devices is just an example, and a plurality of terminal devices and the like may be included in the information processing system. The information processing apparatus 10 and the terminal devices 12 and 14 communicate with each other via a communication path such as a network (for example, local area network (LAN) and the Internet).

In the present exemplary embodiment, the same material is checked by a plurality of checkers. For example, a plurality of checkers are assigned to the same portion of the same material, and the material is checked by the plurality of checkers. The assignment is changed in accordance with the status of the check by the checker.

The material is, for example, a document. The document includes, for example, text strings, images (for example, images in the bitmap format or images in the vector format), and figures. In the document, only the text string may be described, the image may be disposed together with the text string, or only the image may be disposed.

The information processing apparatus 10 is an apparatus that performs a process, for example, a process of assigning a checker to a portion to be checked in a material. The information processing apparatus 10 is, for example, a server or a personal computer (referred to as a “PC” below).

The terminal device 12 is a device used by a requester who requests the checker to check a material. The requester requests the information processing apparatus 10 to request checking of the material by using the terminal device 12.

The terminal device 14 is a device used by the checker who checks the material. The checker checks the material by using the terminal device 14. In a case where a plurality of checkers check the material by using the terminal devices 14 of the plurality of checkers, the terminal device 14 of each of the checkers communicates with the information processing apparatus 10, and each checker checks the material by using the corresponding terminal device 14. A plurality of checkers may check the material by using one terminal device 14.

The terminal devices 12 and 14 are, for example, a PC, a tablet PC, a smartphone, a portable phone, or the like.

The requester may request checking of the material by using the information processing apparatus 10 without using the terminal device 12. In this case, the terminal device 12 may not be included in the information processing system. Similarly, the checker may check the material by using the information processing apparatus 10 without using the terminal device 14. In this case, the terminal device 14 may not be included in the information processing system.

The information processing apparatus 10 includes a reception unit 16, an output unit 18, a role management unit 20, a role acquisition unit 22, a check status acquisition unit 24, a check status management unit 26, a determination unit 28, and an evaluation management unit 30.

The reception unit 16 receives information transmitted from the terminal devices 12 and 14 to the information processing apparatus 10, and receives the input by the requester or the checker.

The output unit 18 outputs information to the terminal devices 12 and 14. For example, the output unit 18 causes the terminal devices 12 and 14 to display various types of information. Specifically, the output unit 18 displays a screen for requesting checking of a material on the display of the terminal device 12, and displays a screen for checking the material on the display of the terminal device 14.

The role management unit 20 stores information indicating the role of each candidate for the material, in the memory, and manages the role of each candidate. For example, for each candidate, information for identifying the candidate (for example, information indicating the name of the candidate, information indicating the account of the candidate, and the ID of the candidate) and information indicating the role are managed in association with each other. The candidate is a person as the candidate for the checker and is registered in advance in the information processing apparatus 10. As will be described later, the candidate is assigned as the checker to a portion to be checked in the material. The role corresponds to, for example, a field in which the candidate has knowledge, a field in which the candidate is familiar, a field in which the candidate is skilled, or the authority to approve the candidate.

The role acquisition unit 22 acquires information indicating the role of the candidate from the role management unit 20.

The check status acquisition unit 24 acquires information indicating the check status of each checker for the material. The check status means, for example, a checker who performs checking, a material, and a portion of the material, which is checked by the checker. In a case where the checker checks the material, a comment may or may not be provided. In a case where the checker makes a comment, the check status acquisition unit 24 acquires the comment.

For example, the information indicating the check status includes the information for identifying the checker (for example, information indicating the name of the checker, information indicating the account of the checker, and the ID of the checker), information for identifying a material as a check target (for example, information indicating the name of the material and the ID of the material), information for identifying a portion checked by the checker, information indicating the date and time on which the checker checks the material, and information for identifying a requester (for example, information indicating the name of the requester, information indicating the account of the requester, and the ID of the requester). In a case where the checker makes a comment, information indicating the comment is also included in the information indicating the check status.

The check status management unit 26 stores the information indicating the check status of each checker, which is acquired by the check status acquisition unit 24, in the memory, and manages the check status of each checker.

The determination unit 28 determines a person who is to check the material from one or a plurality of candidates, as the checker, based on the role of each candidate. The determination unit determines a portion to be checked by the checker in the material and assigns the checker to the portion to be checked. The determination unit 28 changes the checker who is to check the material or changes the portion where the checker is to check, depending on the check status of each checker with respect to the material.

The evaluation management unit 30 stores information indicating the evaluation of the candidate in the memory and manages the evaluation of the candidate. For example, the evaluation is expressed by points, and the evaluation management unit 30 manages the points of the candidate. In a case where the content of checking by the checker who checks the material is evaluated by the requester, the evaluation management unit 30 updates the points of the checker in accordance with the evaluation. The role management unit 20 updates the role of the checker in accordance with the updated points.

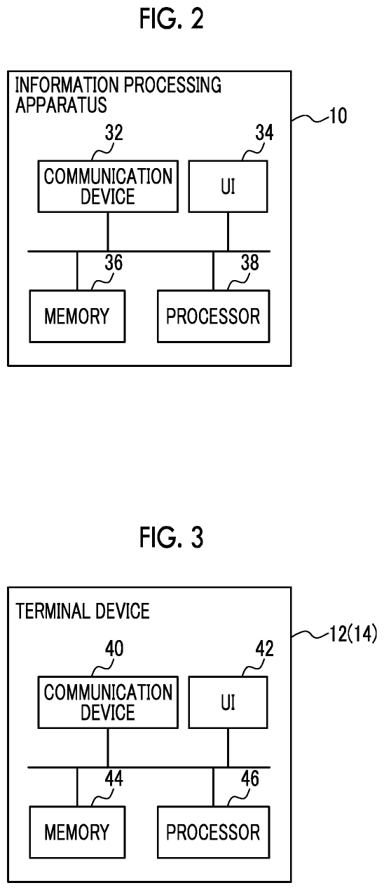

The hardware configuration of the information processing apparatus 10 will be described below with reference to FIG. 2. FIG. 2 illustrates an example of the hardware configuration of the information processing apparatus 10.

The information processing apparatus 10 includes, for example, a communication device 32, a UI 34, a memory 36, and a processor 38.

The communication device 32 is a communication interface having a communication chip, a communication circuit, and the like. The communication device has a function of transmitting information to another device and a function of receiving information from the other device. The communication device 32 may have a wireless communication function or a wired communication function.

The UI 34 is a user interface and includes at least one of a display or an operation device. The display is a display device such as a liquid crystal display and an EL display. The operation device is a keyboard, an input key, an operation panel, or the like. The UI 34 may be a UI such as a touch panel having both the display and the operation device.

The memory 36 is a device that forms one or a plurality of storage regions for storing various types of information. Examples of the memory 36 include a hard disk drive, various types of memories (for example, RAM, DRAM, and ROM), other storage devices (for example, optical disk), and a combination thereof. One or a plurality of memories 36 are included in the information processing apparatus 10. The memory 36 stores the information indicating the role of each candidate, the information indicating the check status of each checker, and the information indicating the evaluation of each candidate.

The processor 38 is configured to control the operations of the units in the information processing apparatus 10. The processor 38 may include a memory. For example, the processor 38 executes a program to realize functions of the reception unit 16, the output unit 18, the role management unit 20, the role acquisition unit 22, the check status acquisition unit 24, the check status management unit 26, the determination unit 28, and the evaluation management unit 30. The program is stored in, for example, the memory 36.

The hardware configuration of the terminal devices 12 and 14 will be described below with reference to FIG. 3. FIG. 3 illustrates an example of the hardware configuration of the terminal devices 12 and 14.

Each of the terminal devices 12 and 14 includes, for example, a communication device 40, a UI 42, a memory 44, and a processor 46.

The communication device 40 is a communication interface having a communication chip, a communication circuit, and the like. The communication device has a function of transmitting information to another device and a function of receiving information from the other device. The communication device 40 may have a wireless communication function or a wired communication function.

The UI 42 is a user interface and includes at least one of a display or an operation device. The display is a display device such as a liquid crystal display and an EL display. The operation device is a keyboard, an input key, an operation panel, or the like. The UI 42 may be a UI such as a touch panel having both the display and the operation device.

The memory 44 is a device that forms one or a plurality of storage regions for storing various types of information. Examples of the memory 44 include a hard disk drive, various memories (for example, RAM, DRAM, and ROM), other storage devices (for example, optical disk), and a combination thereof. One or a plurality of memories 44 are included in each of the terminal devices 12 and 14.

The processor 46 is configured to control the operation of the units in the terminal devices 12 and 14. The processor 46 may include a memory.

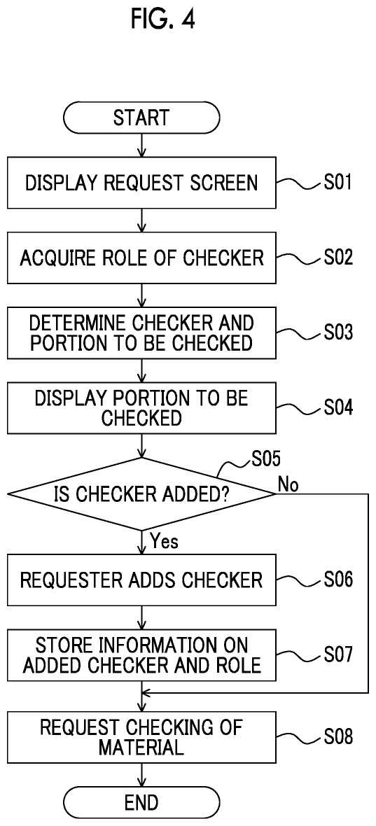

A flow of a process in a case where checking a material is requested will be described below with reference to FIG. 4. FIG. 4 illustrates a flowchart illustrating the flow of the process.

In a case where the requester uses the terminal device 12 to issue an instruction to display a screen (referred to as a “request screen” below) for requesting checking of a material, the request screen is displayed on the display of the terminal device 12 (S01). For example, the output unit 18 displays the request screen on the display of the terminal device 12. The material as a check target is stored in, for example, the terminal device 12 or a document management system. The checker designates the material as the check target, by using the terminal device 12.

Then, the role acquisition unit 22 acquires information indicating the role of the candidate from the role management unit 20 (S02). For example, a plurality of candidates are registered in advance in the information processing apparatus 10, and information indicating the role of each candidate is stored in the memory in advance and managed by the role management unit 20. The role acquisition unit 22 acquires the information indicating the role of each candidate, which is registered in the information processing apparatus 10, from the role management unit 20.

Then, the determination unit 28 determines one or a plurality of checkers who are to check the material, from the plurality of candidates based on the role of each candidate. The determination unit determines a portion to be checked in the material by each checker (S03). Thus, the portion to be checked in the material is assigned to each checker.

Then, the output unit 18 displays the content determined by the determination unit 28, on the display of the terminal device 12 (S04).

In a case where the requester intends to add a checker (S05, Yes), the requester adds the checker on the request screen (S06). The requester may designate the role of the added checker.

Information indicating the added checker and the role is stored in the memory and managed by the role management unit 20 (S07).

Then, the requester requests checking of the material on the request screen (S08). In a case where the requester requests checking of the material, the output unit 18 may transmit information indicating the request to the terminal device 14 of each checker.

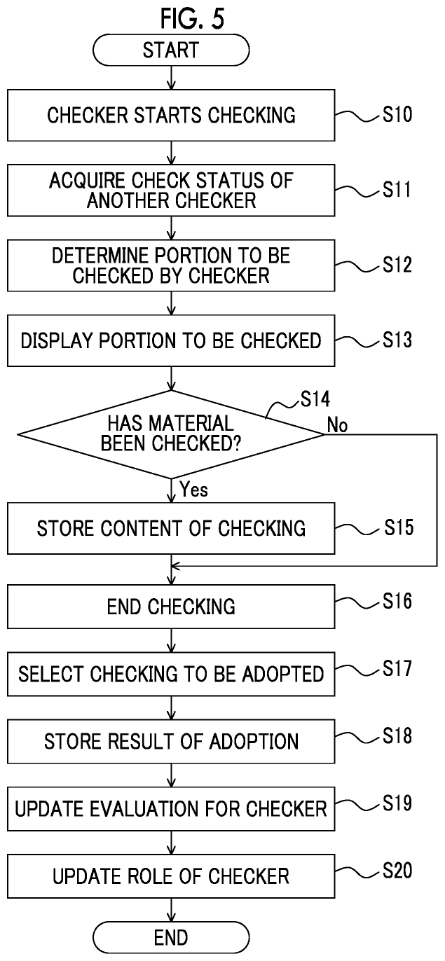

A flow of a process in a case where the material is checked will be described below with reference to FIG. 5. FIG. 5 illustrates a flowchart illustrating the flow of the process.

The checker starts checking the material (S10). For example, in a case where the checker uses the terminal device 14 to issue an instruction to display a screen (referred to as a “check screen” below) for checking a material, the check screen is displayed on the display of the terminal device 14. For example, the output unit 18 displays the check screen on the display of the terminal device 14. Here, it is assumed that the checker A checks a material.

The check status acquisition unit 24 acquires information indicating the check status of another checker for the same material as the material checked by the checker A (S11).

Then, the determination unit 28 determines a portion to be checked by the checker A, based on the check status of the other checker (S12). For example, the determination unit 28 changes the portion to be checked, which is determined in Step S03, in accordance with the check status of the other checker.

The output unit 18 displays a portion to be checked by the checker A, which is determined in Step S12, on the display of the terminal device 14 of the checker A (S13).

In a case where the checker A has checked the material by using the terminal device 14 (S14, Yes), the check status management unit 26 stores the information indicating the content of checking performed by the checker A, in the memory, to manage the content of the checking as the check status by the checker A (S15). For example, in a case where the checker A makes a comment, the check status management unit 26 stores the information indicating the comment in the memory.

In a case where the checker A issues an instruction to end the checking by using the terminal device 14, the checking by the checker A is ended (S16). The checker A may end the checking without performing the check (S14, No).

In a case where a checker other than the checker A checks the material, the same process as described above is performed in the similar manner to a case where the checker A checks the material.

After the material is checked by the checker, the check may be evaluated by the requester. The processes of Steps S17 to S20 are processes related to the evaluation. The processes of Steps S17 to S20 will be described.

In a case where the requester uses the terminal device 12 to issue an instruction to display the content of checking by the checker, the output unit 18 displays the content of the checking by each checker on the display of the terminal device 12. In a case where the checker makes a comment, the comment is also displayed. The requester refers to the content of the checking by each checker and evaluates the content of the checking by each checker. For example, the requester selects the check to be adopted (S17).

The check status management unit 26 stores, in the memory, information indicating the evaluation by the requester for the content of the checking by each checker (S18).

The evaluation management unit 30 updates the evaluation for each checker based on the evaluation by the requester for the content of the checking by each checker (S19). The role management unit 20 updates the role of each checker based on the updated evaluation (S20).

A specific example of the present exemplary embodiment will be described below.

Specific Example of Process in Case where Requester Requests Checking of Material

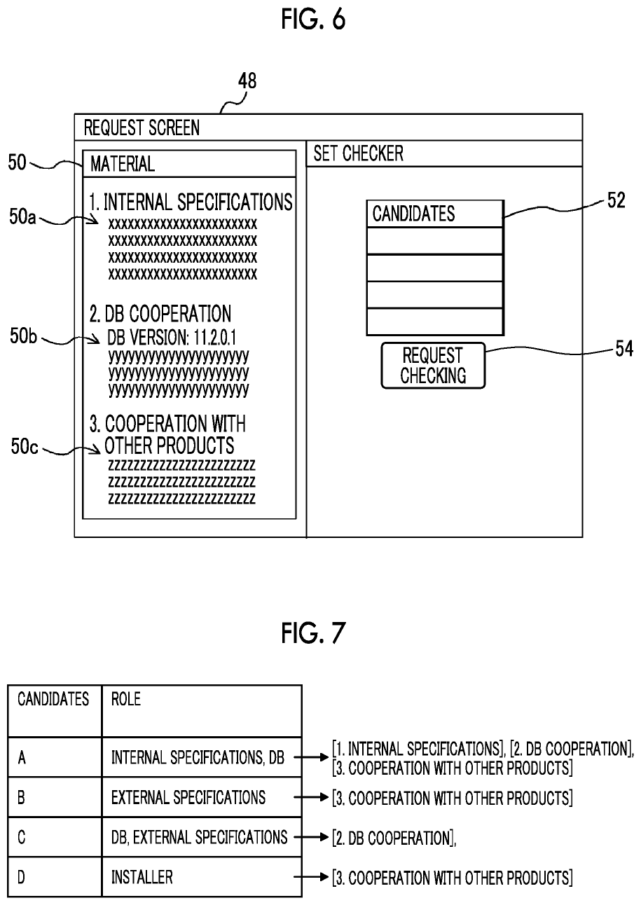

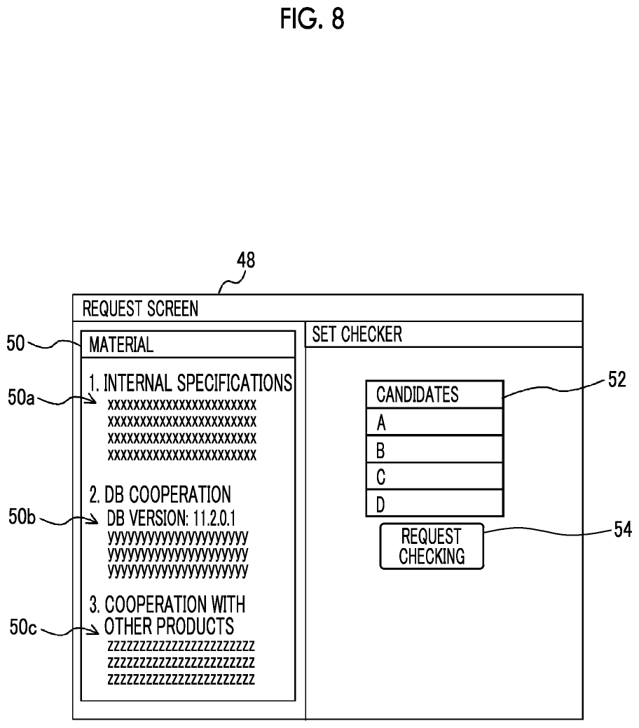

A specific example of the process in a case where the requester requests the checker to check the material will be described below with reference to FIGS. 6 to 8. FIGS. 6 and 8 illustrate the request screen. FIG. 7 illustrates a specific example of the role of the candidate. The specific example will be described below with reference to the flowchart illustrated in FIG. 4.

In a case where the requester issues an instruction to display the request screen by using the terminal device 12, a request screen 48 illustrated in FIG. 6 is displayed on the display of the terminal device 12 (S01).

A material 50 as a target of checking is displayed on the request screen 48. For example, a list of materials is displayed on the request screen 48. Ina case where the checker selects the material 50 as the target of checking, from the list, the material 50 is displayed on the request screen 48. For example, a text string is described in the material 50. In addition, an image may be disposed on the material 50.

The material 50 includes one or a plurality of items. Each of the items may be defined by the checker or may be defined in advance without being defined by the checker. In the example illustrated in FIG. 6, the material 50 includes items 50a, 50b, and 50c. The item 50a is an item “1. Internal specifications”. The item 50b is an item “2. DB cooperation”. The item 50c is an item “3. Cooperation with other products”. The item corresponds to an example of a portion to be checked.

A list 52 of candidates is displayed on the request screen 48. In a case where the candidate who is to check the material is determined as the checker, the information for identifying the candidate is included in the list 52 and displayed on the request screen 48.

A button 54 is displayed on the request screen 48. The button 54 is a button for requesting checking of the material. In a case where the requester presses the button 54, checking of the material is requested.

In a case where the requester requests checking of the material, the role acquisition unit 22 acquires information indicating the role of each candidate, from the role management unit 20 (S02). Here, as an example, the role refers to a field in which the candidate has knowledge (also simply referred to as a “field of the candidate” below).

FIG. 7 illustrates specific examples of fields of the candidates. The field of each candidate illustrated in FIG. 7 is managed by the role management unit 20.

In the example illustrated in FIG. 7, candidates A, B, C, and D are registered in advance in the information processing apparatus 10, and the field of each of the candidates A, B, C, and D is managed by the role management unit 20.

The candidate A has knowledge about internal specifications and a DB (database), and thus the fields of the candidate A are “internal specifications” and “DB”. The candidate B has knowledge about external specifications, and the field of the candidate B is “external specifications”. The candidate C has knowledge about the DB and the external specifications, and the fields of the candidate C are “DB” and “external specifications”. The candidate D has knowledge about an installer, and the field of the candidate D is “installer”. For example, the candidate A and the fields “internal specifications” and “DB” are associated with each other, and are managed by the role management unit 20. This is similarly applied to other candidates.

The role acquisition unit 22 may acquire information indicating the fields of all the candidates registered in the information processing apparatus 10, or may acquire information indicating the fields of some candidates. Here, as an example, the role acquisition unit 22 acquires information indicating the field of each of the candidates A, B, C, and D from the role management unit 20.

Then, the determination unit 28 determines, as the checker, the candidate who is to check the material 50, from the candidates A, B, C, and D, based on the field of each of the candidates A, B, C, and D. Then, the determination unit determines the item to be checked in the material 50 by each checker (S03). The process of the determination unit 28 will be described below in detail.

In a case where a viewpoint of checking is defined for the item in the material 50, the determination unit 28 assigns a checker who has knowledge in the field about the viewpoint of checking, to the item. In a case where the viewpoint of checking is not defined for the item, the determination unit assigns a plurality of checkers having knowledge in different fields to the item, and does not assign a plurality of checkers having knowledge in the same field to the item. The viewpoint means what kind of thoughts, knowledge, viewpoints, and the like is to be used to check the item in the material.

For example, the viewpoint “internal specifications” is defined in the item 50a. The determination unit 28 assigns the candidate A having knowledge of the field “internal specifications” regarding the viewpoint “internal specifications”, to the item 50a as the checker of the item 50a.

The determination unit 28 assigns a certain item to all candidates having knowledge in the field regarding the viewpoint defined in the item. For example, because the viewpoint “DB” is defined in the item 50b and the candidates A and C have knowledge of the field “DB”, the determination unit 28 assigns the candidates A and C to the item 50b as the checkers. This is similarly applied to other items.

The viewpoint of checking is not defined for the item 50c “3. Cooperation with other products”. In this case, the determination unit 28 assigns the checkers A, B, and D to the item 50c as the checkers, for example. Because the checkers A and C have knowledge of the same field “DB”, the determination unit 28 does not assign the checker C to the item 50c. The candidate C may be assigned to the item 50c as the checker, instead of the candidate A.

FIG. 7 illustrates the assignment of the candidates to the items. The item 50a “1. Internal specifications”, the item 50b “2. DB cooperation”, and the item 50c “3. Cooperation with other products” are assigned to the candidate A. The item 50c “3. Cooperation with other products” is assigned to the candidate B. The item 50b “2. DB cooperation” is assigned to the candidate C. The item 50c “3. Cooperation with other products” is assigned to the candidate D.

A timing at which the viewpoint of checking is defined for the item is when the material 50 is created, when checking of the material 50 is requested, and the like.

Depending on the field of the candidate and the viewpoint defined for the item, the candidate may not be assigned to the item as the checker.

A plurality of viewpoints may be defined for one item. For example, the viewpoint “DB” and other viewpoints (for example, “external specifications”) may be defined for the item 50b “2. DB cooperation”. In this case, the determination unit 28 may assign a candidate having knowledge of the field “DB” and a candidate having knowledge of the field “external specifications” to the item 50b “2. DB cooperation”. The determination unit may assign a candidate having knowledge of both the field “DB” and the field “external specifications” to the item 50b “2. DB cooperation”.

In a case where the candidate is assigned to the item to be checked, the output unit 18 displays the result of the assignment on the display of the terminal device 12 (S04). FIG. 8 illustrates a display example. As illustrated in FIG. 8, the information for identifying the candidates A, B, C, and D is included in the list 52 and displayed on the request screen 48. As described in Steps S05 to S07 described above, the requester may add a checker. The requester may exclude the candidate from the checkers by deleting the candidate from the list 52.

In a case where the requester presses the button 54 on the request screen 48, the request for checking the material 50 is completed. For example, the candidates A, B, C, and D are defined as checkers of the material 50. In the following descriptions, it is assumed that the candidates A, B, C, and D defined as the checkers are referred to as checkers A, B, C, and D. For example, the output unit 18 transmits information indicating the request for checking the material 50 to the terminal device 14 of each of the checkers A, B, C, and D.

Specific Example of Process in Case where Checker Checks Material

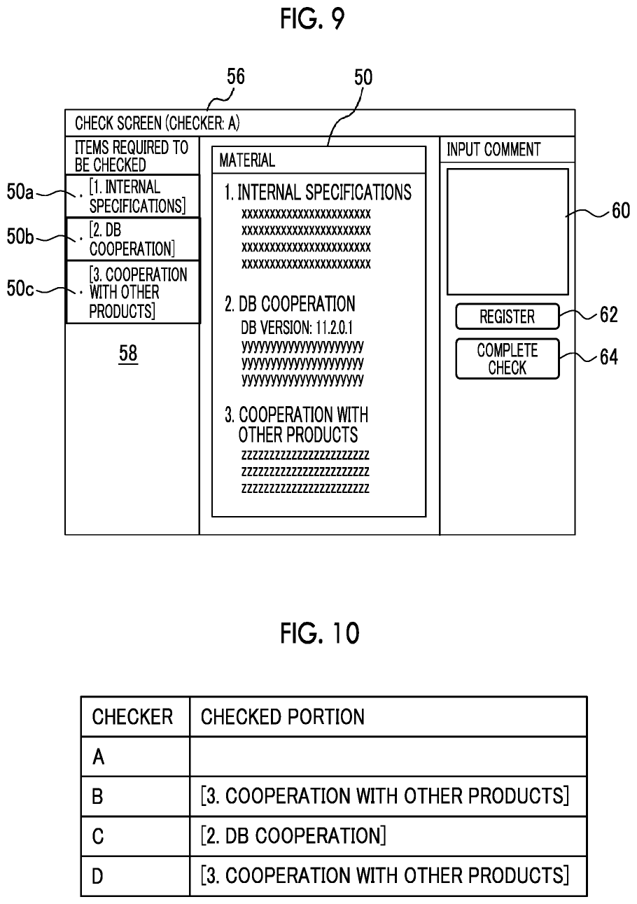

A specific example of the process in a case where the checker checks the material will be described below with reference to FIGS. 9 to 14. FIGS. 9 and 11 to 13 illustrate a check screen. FIG. 10 illustrates the checked item. FIG. 14 illustrates the comment of the checker. The specific example will be described below with reference to the flowchart illustrated in FIG. 5. It is assumed that the checker A checks the material 50. The checker A corresponds to an example of one checker.

In a case where the checker A issues an instruction to display the check screen by using the terminal device 14, a check screen 56 illustrated in FIG. 9 is displayed on the display of the terminal device 14 (S10).

In the example illustrated in FIG. 9, all the contents of the material 50 (that is, the contents of the items 50a, 50b, and 50c) being the target of checking are displayed on the check screen 56.

A region 58 is formed on the check screen 56. An item for which a check proposal is made to the checker A is displayed in the region 58. Here, as an example, all the items (for example, items 50a, 50b, 50c) included in the material 50 are displayed.

A comment column 60 is formed on the check screen 56. The checker A may write a comment in the comment column 60 in a case of checking the item, or may check the item without writing the comment in the comment column 60.

Buttons 62 and 64 are displayed on the check screen 56. The button 62 is a button for registering the check of the item. The button 64 is a button for an instruction to complete the checking of the material 50. The buttons 62 and 64 may be provided for each item displayed in the region 58.

An operation of the checker in a case of checking the item will be described below.

The checker A designates an item and checks the item. The checker A may designate the item displayed in the region 58 and check the designated item, or may designate the item in the material 50 displayed on the check screen 56 and check the designated item. For example, in a case where the checker A designates the item 50a, writes a comment in the comment column 60, and then presses the button 62, a point that the item 50a is checked by the checker A is registered in the information processing apparatus 10, and the comment is registered as a comment of the checker A for the item 50a. The check status acquisition unit 24 acquires the point that the item 50a is checked by the checker A, and the comment of the checker A for the item 50a, as the check status of the checker A for the material 50. Information indicating the check status of the checker A is managed by the check status management unit 26.

In a case where the checker A designates the item 50a and then presses the button 62 without writing the comment in the comment column 60, a point that the item 50a is checked by the checker A without the comment being written is registered in the information processing apparatus 10. The check status acquisition unit 24 acquires the point that the item 50a is checked by the checker A without the comment being written, as the check status of the checker A for the material 50. Information indicating the check status of the checker A is managed by the check status management unit 26.

The checker A may designate the field and then check the item. In this case, the check status management unit 26 manages the information indicating the field with being included in the information indicating the check status of the checker A. For example, in a case where the checker A designates the item 50a and the field “internal specifications”, and then presses the button 62 with or without writing a comment, the check status management unit 26 manages a point that the checker A checks the item 50a from the viewpoint of the field “internal specifications”, as the check status of the checker A for the material 50. Although the viewpoint “internal specifications” is defined for the item 50a, the checker A may check the item 50a from another viewpoint. For example, in a case where the checker A designates the item 50a and the field “DB”, and then presses the button 62 with or without writing a comment, the check status management unit 26 manages a point that the checker A checks the item 50a from the viewpoint of the field “DB”, as the check status of the checker A for the material 50.

The same screen as the check screen 56 illustrated in FIG. 9 is also displayed on the displays of the terminal devices 14 of the checkers B, C, and D.

For example, although only the item 50c “3. Cooperation with other products” is assigned to the checker B, all the contents of the material 50 are displayed on the check screen displayed for the checker B, and all the items (for example, items 50a, 50b, and 50c) are displayed in the region 58, similar to the check screen 56 illustrated in FIG. 9. The checker B may check the item (for example, items 50a and 50b) that is not assigned to the checker B.

The output unit 18 may separately display the item assigned to the checker and the item not assigned to the checker so that the item assigned to the checker can be recognized. For example, the output unit 18 may display the items 50a and 50b which are not assigned to the checker B in gray out, or may emphasize and display the item 50c assigned to the checker B. Emphasizing and displaying an item means, for example, highlighting and displaying the item, and displaying a frame surrounding the item. For example, the item 50c which is assigned to the checker B and is emphasized and displayed is proposed to the checker B as an item to be checked by the checker B. The items 50a and 50b which are not assigned to the checker B are proposed to the checker B as items which are not to be checked or may not be checked by the checker B. Even in a case where such a display is performed, the checker B may be able to check the items 50a and 50b which are not assigned to the checker B. This is similarly applied to other checkers.

The output unit 18 may display only the item assigned to the checker, in the region 58. As illustrated in FIG. 7, the item 50a “1. Internal specifications”, the item 50b “2. DB cooperation”, and the item 50c “3. Cooperation with other products” are assigned to the checker A. Thus, the items 50a, 50b, and 50c are displayed in the region 58 on the check screen 56 for the checker A. In this manner, it may be proposed to the checker A that the items 50a, 50b, and 50c are items to be checked by the checker A. All the items (that is, items 50a, 50b, and 50c) are assigned to the checker A, and thus the display example thereof is the same as the display example illustrated in FIG. 9. The item 50c “3. Cooperation with other products” is assigned to the checker B, and thus the item 50c is displayed in the region 58 on the check screen 56 for the checker B. In this manner, it may be proposed to the checker B that the item 50c is an item to be checked by the checker B. The item 50b “2. DB cooperation” is assigned to the checker C, and thus the item 50b is displayed in the region 58 on the check screen 56 for the checker C. In this manner, it may be proposed to the checker C that the item 50b is an item to be checked by the checker C. The item 50c “3. Cooperation with other products” is assigned to the checker D, and thus the item 50c is displayed in the region 58 on the check screen 56 for the checker D. In this manner, it may be proposed to the checker D that the item 50c is an item to be checked by the checker D. Even in a case where such a display is performed, each checker may be able to check the item which is not assigned to the checker. For example, the checker may designate an item which is not assigned to the checker in the material 50 displayed on the check screen 56, and then check the item.

In a case where the material 50 is checked by the checker, the check status acquisition unit 24 acquires the information indicating the check status of the checker (S11). The check status of the checker is managed by the check status management unit 26.

FIG. 10 illustrates an example of the check status of each checker. In the example illustrated in FIG. 10, the item 50c “3. Cooperation with other products” is checked by the checker B. The item 50b “2. DB cooperation” is checked by the checker C, and the item 50c “3. Cooperation with other products” is checked by the checker D. The checker A does not check the material 50. The check status of each checker illustrated in FIG. 10 is managed by the check status management unit 26.

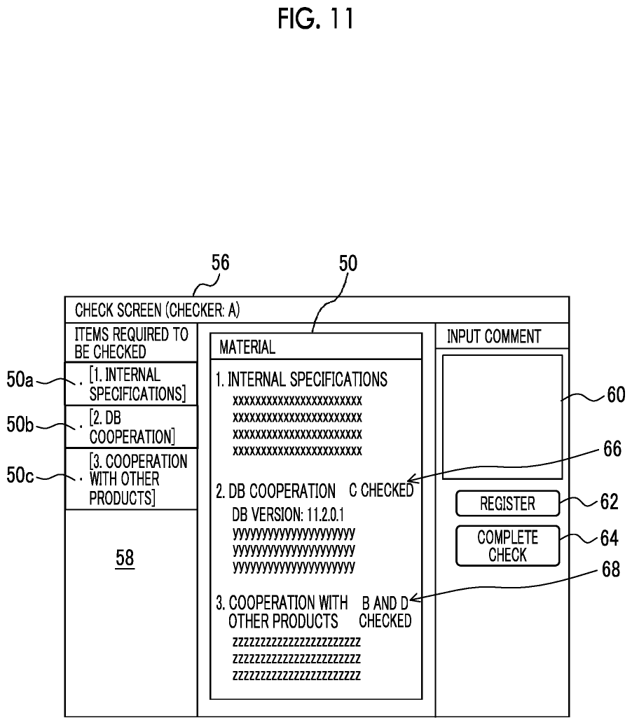

The output unit 18 may display the check status of the checker on the check screen 56. For example, as illustrated in FIG. 11, on the check screen 56 displayed to the checker A, information (for example, text string “C checked”) indicating that the item 50b “2. DB cooperation” has been checked by the checker C is displayed as indicated by the reference sign 66, and information (for example, text string “B and D checked”) indicating that the item 50c “3. Cooperation with other products” has been checked by the checkers B and D is displayed as indicated by the reference sign 68.

The checker may check the item checked by another checker. For example, the checker A may check the item 50b checked by the checker C, or may check the item 50c checked by the checkers B and D.

The output unit 18 may separately display the items checked by the checker other than the checker A and the items not checked by the checker other than the checker A. For example, the output unit 18 may display the items checked by the checker other than the checker A in gray out, or may emphasize and display the items not checked by the checker other than the checker A.

The determination unit 28 determines an item to be checked by the checker A, based on the check status of the checkers B, C, and D other than the checker A (S12). The output unit 18 displays the item to be checked by the checker A, on the check screen 56 (S13).

For example, the determination unit 28 excludes the items checked by the checkers other than the checker A from the items to be checked by the checker A, and determines the item which is not checked by the other checkers, as the item to be checked by the checker A. In this case, the output unit 18 separately display the item to be checked by the checker A and other items. For example, the output unit 18 may emphasize and display the item to be checked by the checker A in the material 50 displayed on the check screen 56, or may display other items in gray out. Describing with a specific example, in a case where the item 50c “3. Cooperation with other products” is checked by the checker (for example, checker B) other than checker A, the determination unit 28 excludes the item 50c “3. Cooperation with other products” from the items to be checked by the checker A, and the output unit 18 displays the item 50c “3. Cooperation with other products” in gray out. The output unit 18 may not display the item 50c in the region 58. As described above, the items checked by other checkers are not proposed to the checker A as the items to be checked by checker A. The items which are not checked by other checkers are proposed to the checker A as the items to be checked by the checker A. This is similarly applied to other checkers.

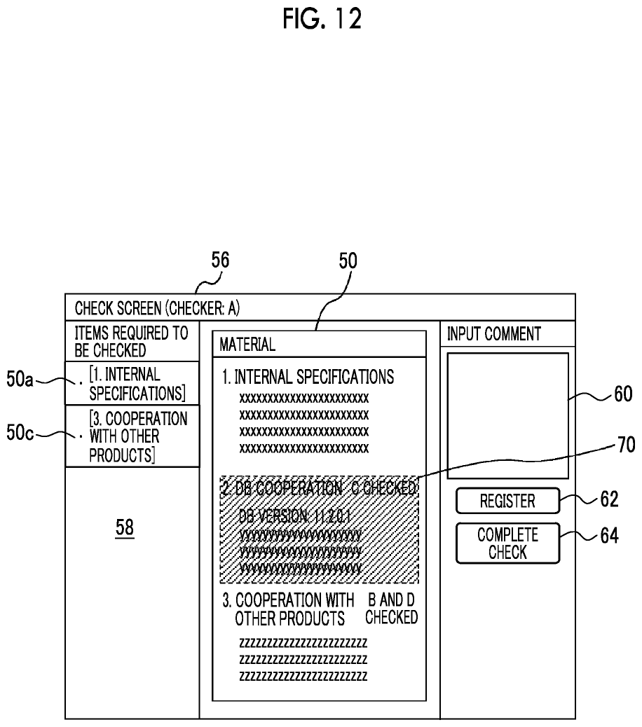

The determination unit 28 may exclude the item checked by another checker having knowledge of the same field as the checker A, from the items to be checked by the checker A, and determine the item which is not checked by other checkers having the knowledge of the same field, as the item to be checked by the checker A. For example, the checkers A and C have knowledge of the same field “DB” and are assigned to the item 50b “2. DB cooperation” (see FIG. 7). Because the item 50b “2. DB cooperation” has already been checked by the checker C, the determination unit 28 excludes the item 50b “2. DB cooperation” from the items to be checked by the checker A. In this case, for example, as indicated by the reference sign 70 in FIG. 12, the output unit 18 displays the item 50b in the material 50 displayed on the check screen 56, in gray out. The output unit 18 does not display the item 50b in the region 58. As described above, the item checked by other checkers having knowledge in the same field as the field of the checker A is not proposed to the checker A as the item to be checked by checker A. The item which is not checked by other checkers having knowledge in the same field as the checker A is proposed to the checker A as the item to be checked by the checker A.

The determination unit 28 may not exclude the item checked by another checker having knowledge in a field different from the field of the checker A, from the items to be checked by the checker A. For example, the checkers A, B, and D have knowledge in different fields and are assigned to the item 50c “3. Cooperation with other products” (see FIG. 7). Although the item 50c “3. Cooperation with other products” has already been checked by the checkers B and D, the checkers A, B, and D have knowledge in different fields. Thus, the determination unit 28 does not exclude the item 50c “3. Cooperation with other products” from the items to be checked by the checker A. As illustrated in FIG. 12, the item 50c in the material 50 is not displayed in gray out, and the item 50c is displayed in the region 58. As described above, the item checked by another checker having knowledge in the field different from the field of the checker A is proposed to the checker A as the item to be checked by the checker A.

The output unit 18 may display the item which is assigned to the checker A and is not checked by another checker, on the check screen 56 as the item to be checked by the checker A. For example, in a case where the items 50a and 50b are assigned to the checker A, and the items 50a and 50b are not checked by any checker, the output unit 18 displays the item 50c in the material 50 displayed on the check screen 56 in gray out, and displays the items 50a and 50b in the region 58. In a case where the item 50b is checked by another checker (for example, checker C), the output unit 18 displays the items 50b and 50c in gray out and displays only the item 50a in the region 58. The output unit 18 may emphasize and display the item (for example, item 50a) to be checked by the checker A. As described above, the item which is assigned to the checker A and checked by other checkers is not proposed to the checker A as the item to be checked by the checker A. The item which is assigned to the checker A and is not checked by other checkers is proposed to the checker A as the item to be checked by the checker A. This is similarly applied to other checkers.

The output unit 18 may determine the item which is assigned to the checker A and is not checked by another checker having knowledge in the same field as the field of the checker A, as the item to be checked by the checker A. For example, in a case where the items 50a and 50b are assigned to the checker A, and the item 50b is checked by the checker C, the output unit 18 displays the items 50b and 50c in the material 50 displayed on the check screen 56 in gray out, and displays only the item 50a in the region 58. The output unit 18 may emphasize and display the item (for example, item 50a) to be checked by the checker A. As described above, the item which is assigned to the checker A and checked by other checkers having knowledge in the same field as the field of the checker A is not proposed to the checker A as the item to be checked by checker A. The item which is assigned to the checker A and is not checked by other checkers having knowledge in the same field as the checker A is proposed to the checker A as the item to be checked by the checker A.

The determination unit 28 may not exclude the item which is assigned to the checker A and checked by another checker having knowledge in the field different from the field of the checker A, from the items to be checked by the checker A. The output unit 18 may display the item on the check screen 56 as the item to be checked by the checker A. For example, in a case where the items 50b and 50c are assigned to the checker A, and the item 50c is checked by the checker B having knowledge in the field different from the field of the checker A, the determination unit 28 does not exclude the item 50c from the items to be checked by the checker A. In this case, the output unit 18 displays the items 50b and 50c in the region 58, and does not display the items 50b and 50c in gray out. As described above, the item which is assigned to the checker A and checked by another checker having knowledge in the field different from the field of the checker A is proposed to the checker A as the item to be checked by the checker A.

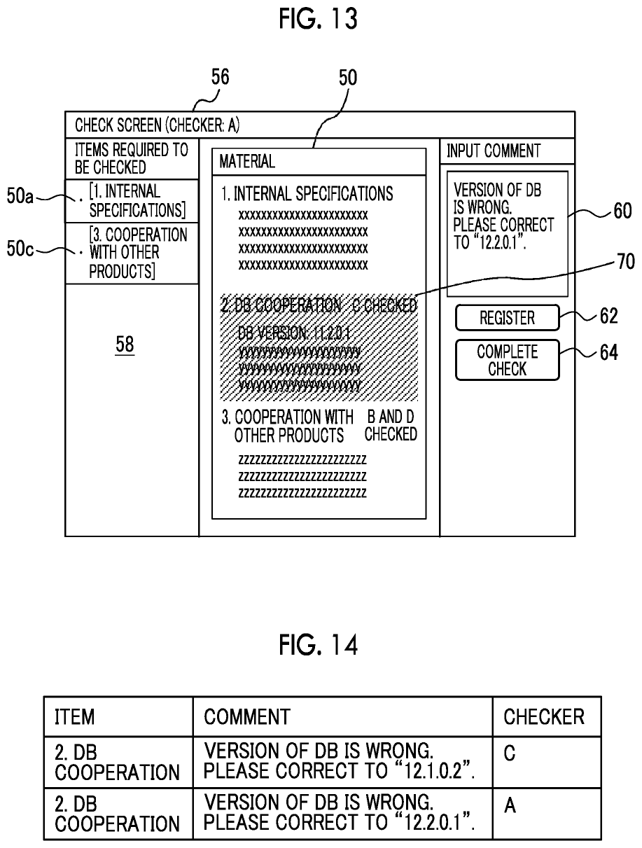

As illustrated in FIG. 13, for example, in a case where the checker A designates the item 50b “2. DB cooperation”, writes a comment in the comment column 60, and then presses the button 62, a point that the item 50b is checked by the checker A is registered in the information processing apparatus 10, and the comment is registered as a comment of the checker A for the item 50b (S14 and S15). The check status acquisition unit 24 acquires the point that the item 50b is checked by the checker A, and the comment of the checker A for the item 50b, as the check status of the checker A for the material 50. Information indicating the check status of the checker A is managed by the check status management unit 26. As described above, the checker A may check the item 50b “2. DB cooperation” excluded from the items to be checked by the checker A.

FIG. 14 illustrates a specific example of the comment of each checker for the item. The checkers A and C make comments for the item 50b. The check status management unit 26 stores information indicating the comments of the checkers A and C for the item 50b in the memory, and manages the comments of the checkers A and C.

In a case where the checker A presses the button 64, checking of the material 50 by the checker A is ended (S16).

In the above-described exemplary embodiment, the output unit 18 may display the item assigned to the checker, in the region 58. For example, the items 50a, 50b, and 50c are assigned to the checker A, and thus the output unit 18 displays the items 50a, 50b, and 50c in the region 58 on the check screen 56 displayed to the checker A. The item 50c is assigned to the checker B, and thus the output unit 18 displays the item 50c in the region 58 on the check screen 56 displayed to the checker B. The item 50b is assigned to the checker C, and thus the output unit 18 displays the item 50b in the region 58 on the check screen 56 displayed to the checker C. The item 50c is assigned to the checker D, and thus the output unit 18 displays the item 50c in the region 58 on the check screen 56 displayed for the checker D. As described above, the item assigned to the checker may be proposed to the checker as the item to be checked by the checker.

Specific Example of Process in Case where Requester Evaluates Content of Checking by Checker

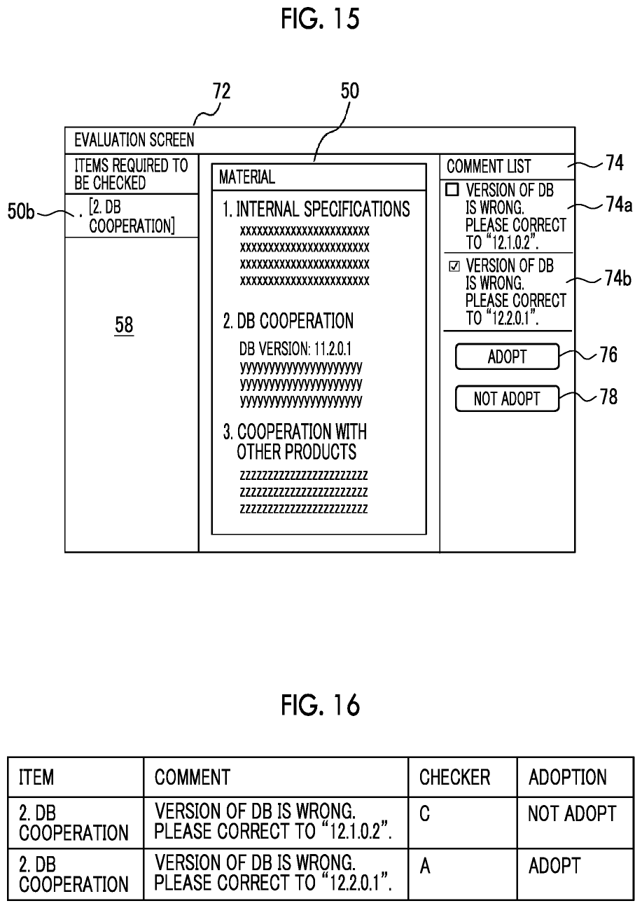

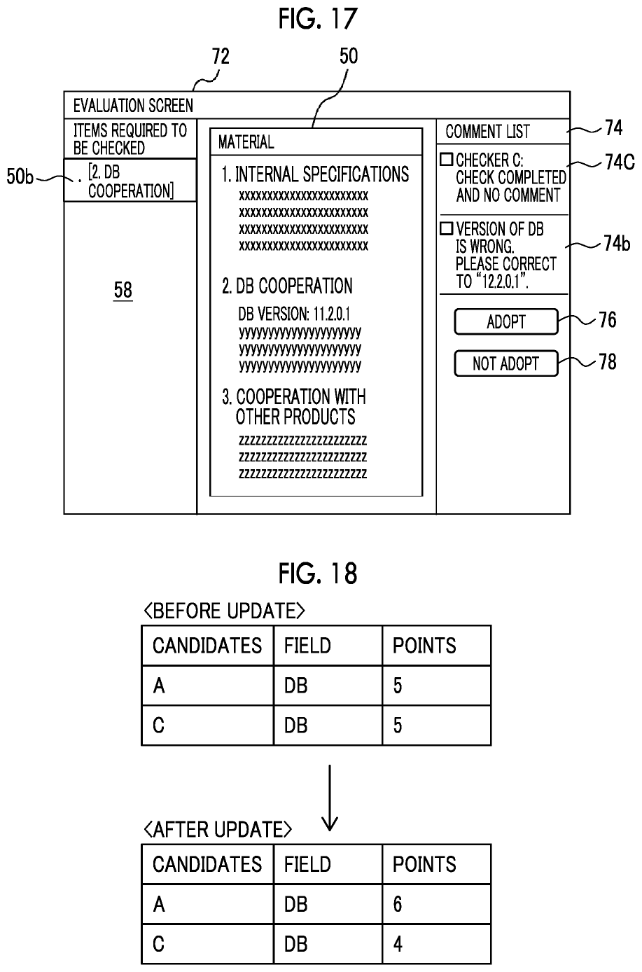

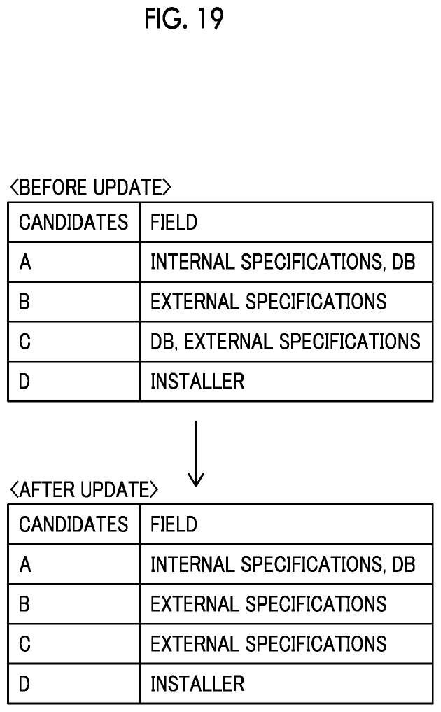

A specific example of the process in a case where the requester evaluates the content of checking by the checker will be described with reference to FIGS. 15 to 19. FIGS. 15 and 17 illustrate a screen (referred to as an “evaluation screen” below) displayed in a case where the content of checking by the checker is evaluated. FIG. 16 illustrates the result of the evaluation. FIG. 18 illustrates the points of the candidate. FIG. 19 illustrates the role of the candidate. The specific example will be described below with reference to the flowchart illustrated in FIG. 5.

In a case where the requester uses the terminal device 12 to issue an instruction to display the content of checking, the output unit 18 displays the evaluation screen on the display of the terminal device 12. FIG. 15 illustrates an evaluation screen 72.

The material 50, items checked by the checker, a list 74 of comments of the checker, and buttons 76 and 78 are displayed on the evaluation screen 72.

For example, in a case where the requester designates an item, the content of checking by the checker for the designated item is displayed on the evaluation screen 72. As another example, even though the requester does not designate the item, the content of the checking for the item checked by the checker may be displayed on the evaluation screen 72.

In the example illustrated in FIG. 15, the comment of the checker for the item 50b is displayed in the list 74. A comment 74a is a comment of the checker C. A comment 74b is a comment of the checker A.

The button 76 is a button for an instruction to adopt the comment. The button 78 is a button for an instruction not to adopt the comment. Only one of the button 76 and the button 78 may be displayed.

In a case where the requester selects the comment and then presses the button 76 (S17), the selected comment is adopted. For example, it is conceivable that the requester selects and adopts a reference comment or the like. The check status management unit 26 stores information indicating the adoption result of the comment in the memory and manages the adoption result (S18).

For example, in a case where the requester selects the comment 74b and then presses the button 76 without selecting the comment 74a, the comment 74a is not adopted, but the comment 74b is adopted. The check status management unit 26 stores, in the memory, information indicating that the comment 74a is not adopted, but the comment 74b is adopted.

In a case where the requester selects the comment, and then presses the button 78, the selected comment is not adopted.

FIG. 16 illustrates the evaluation for each checker. In the example illustrated in FIG. 16, for the item 50b, the comment of the checker C is not adopted, but the comment of the checker A is adopted. The check status management unit 26 stores information indicating whether or not the comment of each of the checkers A and C is adopted, in the memory, and manages whether or not the comment of each of the checkers A and C is adopted.

Information for identifying the checker who has made the comment may be displayed in the comment list 74. For example, the information for identifying the checker C is displayed in a place where the comment 74a is displayed. The information for identifying the checker A is displayed in a place where the comment 74b is displayed. As described above, who has made the comment and what kind of comment is made may be displayed.

The checker may check the material 50 without making a comment. In this case, information indicating that the checker performs checking without making a comment is displayed on the evaluation screen 72. For example, in a case where the checker C checks the item 50b without making a comment, as illustrated in FIG. 17, a checking content 74c indicating that the checker C has checked the item 50b without making a comment is displayed in the list 74. In a case where the requester selects the checking content 74c and then presses the button 76, the checking content 74c is adopted, and the check status management unit 26 manages the result of the adoption.

The evaluation management unit 30 updates the evaluation for each checker based on the evaluation by the requester for the content of the checking by each checker (S19). For example, the evaluation management unit 30 manages points corresponding to the evaluation for each checker and each field, and updates the points of each checker based on the evaluation by the requester. Specifically, in a case where a comment for a certain item is adopted by the requester, the evaluation management unit 30 adds points to the points of the checker in the field corresponding to the viewpoint defined for the item. In a case where the comment for the certain item is not adopted by the requester, the evaluation management unit 30 deducts points from the points of the checker in the field corresponding to the viewpoint defined for the item. This is similarly applied to a case where the checker performs checking without making a comment. In a case where the content of the checking by the checker for a certain item is adopted by the requester, the evaluation management unit 30 adds points to the points of the checker in the field corresponding to the viewpoint defined for the item. In a case where the content of the checking by the checker for the certain item is not adopted by the requester, the evaluation management unit 30 deducts points from the points of the checker in the field corresponding to the viewpoint defined for the item.

FIG. 18 illustrates an example of the points. For example, before the evaluation, for the field “DB”, the points of the candidate A (that is, checker A) are “5”, and the points of the candidate C (that is, checker C) are “5”. In a case where, for the item “2. DB cooperation” in which the viewpoint “DB” is defined, the comment of the checker A is adopted and the comment of the checker C is not adopted, the evaluation management unit 30 adds points to the points of the checker A for the field “DB” (for example, adds one point), and deducts points from the points of the checker C (for example, deducts one point). As a result, the points of the checker A for the field “DB” are changed from “5” to “6”, and the points of the checker C are changed from “5” to “4”. This is similarly applied to a case where the checker performs checking without making a comment. In a case where the content of checking is adopted, points are added. In a case where the content of checking is not adopted, points will be deducted. In the example illustrated in FIG. 17, in a case where the comment or the content of checking is selected, and then the button 78 for not adoption is pressed, the evaluation management unit 30 deducts points from the points of the checker making the comment or the points of the checker performing the checking.

In a case where the checker designates the field and checks the items in the material 50, a point that the checker has checked the item in the material 50 from the viewpoint of the designated field is managed by the check status management unit 26 as the check status of the checker. In this case, in a case where the content of checking by the checker for the item is adopted by the requester, the evaluation management unit 30 adds points to the points of the checker in the field. In a case where the content of the checking by the checker for the item is not adopted by the requester, the evaluation management unit 30 deducts points from the points of the checker in the field.

For example, in a case where the checker A designates the item 50a and the field “DB”, and checks the item 50a with or without writing a comment (for example, case where the button 62 in FIG. 9 is pressed), the check status management unit 26 manages a point that the checker A checks the item 50a from the viewpoint of the field “DB”, as the check status of the checker A for the material 50. In a case where the content of the checking by the checker A for the item 50a is adopted by the requester, the evaluation management unit 30 adds points to the points of the checker A for the field “DB”. In a case where the content of the checking is not adopted by the requester, the evaluation management unit deducts points from the points of the checker A for the field “DB”.

The role management unit 20 updates the role of each checker based on the updated points (S20). Here, as an example, the role management unit 20 updates the field of each checker. For example, a reference value (for example, “5”) of the points is defined. The role management unit 20 compares the updated points to the reference value, and updates the field in accordance with the result of the comparison. A specific process will be described below.

In a case where there is no change in the relation between the updated points of the checker and the reference value for a certain field, the role management unit 20 does not update the field of the checker. For example, in a case where the points of the checker A for the field “internal specifications” are “5” before the points are updated (that is, before the requester performs the evaluation), and the points of the checker A for the field “internal specifications” are “5” after the points are updated (that is, after the requester has performed the evaluation), the role management unit 20 does not change that the checker A has knowledge of the field “internal specifications”, and manages the checker A and the field “internal specifications” in association with each other.

In a case where the updated points of the checker for a certain field are greater than the reference value, the role management unit 20 adds the field in which the points are greater than the reference value, to the field of the knowledge of the checker, and associates the checker with the field. That is, the role management unit 20 manages that the checker has knowledge in the field. For example, it is assumed that the field “external specifications” is not associated with the checker A. In a case where the points of the checker A for the field “external specifications” are “5” before the points are updated, and the points of the checker A for the field “external specifications” are “6” after the points are updated, the role management unit 20 adds the field “external specifications” to the field of the checker A, and manages the checker A and the field “external specifications” in association with each other, assuming that the checker A has knowledge of the field “external specifications”. Even though the points for a certain field are smaller than the reference value (for example, even though the points are “0”), the content of checking is adopted by the requester while the checker checks the material, and the points increase. As a result, it is conceivable that the points are greater than the reference value. In this case, the field is newly associated with the checker.

In a case where the updated points of the checker for a certain field are smaller than the reference value, the role management unit 20 deletes the field in which the points are smaller than the reference value, from the field of the knowledge of the checker, and cancels the association between the checker and the field. That is, the role management unit 20 manages that the checker does not have the knowledge in the field. Describing with the example illustrated in FIG. 18, for the field “DB”, the points of the checker C are “4”, and this is smaller than the reference value. Thus, the role management unit 20 deletes the field “DB” from the fields of the checker C, and cancels the association between the checker C and the field “DB”.

For example, as illustrated in FIG. 19, before the points are updated, it is assumed that the checker C has knowledge of the field “DB” and the field “external specifications”. Thus, the checker C is managed in association with the field “DB” and the field “external specifications”. After the points are updated, the points of the checker C for the field “DB” are smaller than the reference value. Thus, the field “external specifications” is deleted from the fields of the checker C. As a result, the checker C and the field “DB” are not associated with each other, and the checker C and the field “external specifications” are managed in association with each other.

For example, in a case where a new material is checked, the determination unit 28 assigns each candidate to an item in the material based on the updated field of the candidate.

In the present exemplary embodiment, the role of the checker may be the authority of approval. In this case, as a scene to which the process according to the present exemplary embodiment is applied, it is conceivable that a subordinate circulates the material to a plurality of bosses who have the authority of approval in order to obtain the approval for the material, and the plurality of bosses check the material. For example, in a case where bosses A and B have the same authority, and the boss B checks an item X in the material (for example, in a case where the item X is approved), the item X is not proposed to the boss A as the item to be checked. An item for which the boss A has the authority of approval and is not checked by the boss B is proposed to the boss A as the item to be checked by the boss A. As described above, the present exemplary embodiment may be applied to the scene of approving the material.

The functions of the units of the information processing apparatus 10 and the terminal devices 12 and 14 are realized by the cooperation of hardware and software as an example. For example, the processor of each device reads and executes the program stored in the memory of each device to realize the functions of each device. The program is stored in the memory via a recording medium such as a CD or a DVD, or via a communication path such as a network.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a processor configured to:
in a case where a plurality of checkers are assigned to the same portion of the same material, and the material is checked by the plurality of checkers, display a portion that is assigned to a first checker included in the plurality of checkers and has not been checked by a second checker included in the plurality of checkers, on a display of the first checker as a portion to be checked by the first checker.

2. The information processing apparatus according to claim 1,
wherein the second checker has the same role as the first checker for check.

3. The information processing apparatus according to claim 2, wherein the processor is configured to:
display, on the display, a portion that is assigned to the first checker and has been checked by a third checker having a role different from a role of the first checker for check, as the portion to be checked by the first checker.

4. The information processing apparatus according to claim 1, wherein the processor is further configured to:
assign a checker having a role related to a portion to be checked, to each portion to be checked in the material.

5. The information processing apparatus according to claim 2, wherein the processor is further configured to:
assign a checker having a role related to a portion to be checked, to each portion to be checked in the material.

6. The information processing apparatus according to claim 3, wherein the processor is further configured to:
assign a checker having a role related to a portion to be checked, to each portion to be checked in the material.

7. The information processing apparatus according to claim 4, wherein the processor is configured to:
in a case where a viewpoint of checking is defined for a portion to be checked, assign a checker having a role for the viewpoint of checking to the portion to be checked, and
in a case where the viewpoint of the checking is not defined for the portion to be checked, assign a plurality of checkers having roles different from each other to the portion to be checked, and not assign a plurality of checkers having the same role to the portion to be checked.

8. The information processing apparatus according to claim 5, wherein the processor is configured to:
in a case where a viewpoint of checking is defined for a portion to be checked, assign a checker having a role for the viewpoint of checking to the portion to be checked, and
in a case where the viewpoint of the checking is not defined for the portion to be checked, assign a plurality of checkers having roles different from each other to the portion to be checked, and not assign a plurality of checkers having the same role to the portion to be checked.

9. The information processing apparatus according to claim 6, wherein the processor is configured to:
in a case where a viewpoint of checking is defined for a portion to be checked, assign a checker having a role for the viewpoint of checking to the portion to be checked, and
in a case where the viewpoint of the checking is not defined for the portion to be checked, assign a plurality of checkers having roles different from each other to the portion to be checked, and not assign a plurality of checkers having the same role to the portion to be checked.

10. The information processing apparatus according to claim 2,
wherein a check of each checker who has checked the material is evaluated by a requester who requests the plurality of checkers to check the material, and
the processor is configured to:
change a role of each checker in accordance with an evaluation of each checker by the requester.

11. The information processing apparatus according to claim 3,
wherein a check of each checker who has checked the material is evaluated by a requester who requests the plurality of checkers to check the material, and
the processor is configured to:
change a role of each checker in accordance with an evaluation of each checker by the requester.

12. The information processing apparatus according to claim 4,
wherein a check of each checker who has checked the material is evaluated by a requester who requests the plurality of checkers to check the material, and
the processor is configured to:
change a role of each checker in accordance with an evaluation of each checker by the requester.

13. The information processing apparatus according to claim 5,
wherein a check of each checker who has checked the material is evaluated by a requester who requests the plurality of checkers to check the material, and
the processor is configured to:
change a role of each checker in accordance with an evaluation of each checker by the requester.

14. The information processing apparatus according to claim 6,
wherein a check of each checker who has checked the material is evaluated by a requester who requests the plurality of checkers to check the material, and
the processor is configured to:
change a role of each checker in accordance with an evaluation of each checker by the requester.

15. The information processing apparatus according to claim 7,
wherein a check of each checker who has checked the material is evaluated by a requester who requests the plurality of checkers to check the material, and
the processor is configured to:
change a role of each checker in accordance with an evaluation of each checker by the requester.

16. The information processing apparatus according to claim 8,
wherein a check of each checker who has checked the material is evaluated by a requester who requests the plurality of checkers to check the material, and
the processor is configured to:
change a role of each checker in accordance with an evaluation of each checker by the requester.

17. The information processing apparatus according to claim 3,
wherein the checkers having the same role have knowledge in the same field, and
the checkers having different roles have knowledge in different fields.

18. The information processing apparatus according to claim 4,
wherein the checkers having the same role have knowledge in the same field, and
the checkers having different roles have knowledge in different fields.

19. A non-transitory computer readable medium storing a program causing a computer to execute a process comprising:
displaying, in a case where a plurality of checkers are assigned to the same portion of the same material, and the material is checked by the plurality of checkers, a portion that is assigned to a first checker included in the plurality of checkers and has not been checked by a second checker included in the plurality of checkers, on a display of the first checker as a portion to be checked by the first checker.

20. An information processing method comprising:
displaying, in a case where a plurality of checkers are assigned to the same portion of the same material, and the material is checked by the plurality of checkers, a portion that is assigned to a first checker included in the plurality of checkers and has not been checked by a second checker included in the plurality of checkers, on a display of the first checker as a portion to be checked by the first checker.
